(19) United States
(12) Patent Application Publication
(10) Pub. No.: US 2012/0268373 A1
(43) Pub. Date: Oct. 25, 2012

(54) METHOD FOR RECOGNIZING USER'S GESTURE IN ELECTRONIC DEVICE

(75) Inventor: Grzegorz Pawet GRZESIAK, Warsaw (PL)

(73) Assignee: SAMSUNG ELECTRONICS CO., LTD., Gyeonggi-Do (KR)

(21) Appl. No.: 13/451,764

(22) Filed: Apr. 20, 2012

(30) Foreign Application Priority Data
Apr. 21, 2011 (KR) 10-2011-0037365

(51) Int. Cl. G06F 3/033

(52) U.S. Cl. 345/158

(57) ABSTRACT

Provided is a method for recognizing a user's gesture in an electronic device, the method including sensing movement of an object by using a motion sensor, checking a distance between the motion sensor and the movement-sensed object and referring to a preset value which is currently applied in relation to gesture recognition, and adaptively recognizing a gesture corresponding to the movement-sensed object according to the set value and the checked distance.

### CLAIM OF PRIORITY

This application claims the benefit under 35 U.S.C. §119 of a Korean Patent Application filed in the Korean Intellectual Property Office on Apr. 21, 2011 and assigned Serial No. 10-2011-0037365, the entire disclosure of which is hereby incorporated by reference.

### BACKGROUND OF THE INVENTION

1. Field of the Invention

The present invention relates to recognizing a user's gesture by sensing an object's motion.

2. Description of the Related Art

To use electronic products, additional input devices, such as a keyboard, a mouse, etc., are necessary.

Advantageously, the keyboard and the mouse allow the user's input to be made conveniently and rapidly, but there drawbacks and inconvenience in terms of portability which need to be remedied.

Now days, an electronic product can be controlled through a touch screen function without using a keyboard or a mouse. However, the touch screen is not convenient because the screen cannot be partially seen by a part of a user's body (e.g., a finger) when the user touches the screen.

To solve the inconvenience of the touch screen, a gesture recognition function has been provided such that an electronic product can be controlled merely by recognition of a finger gesture, etc. The gesture recognition function enables the user to control various electronic products with much ease.

However, the gesture recognition function is compensated via a sensitivity setting. Generally, when a user inputs a gesture with a finger, the gesture corresponding to finger's motion and movement distance is recognized for input. For example, when a pointer's operation is controlled on a display screen through a gesture recognition of a finger, a pointer's movement distance increases in proportion to a finger's movement distance. Considering that a distance which a pointer moves in proportion to a finger's movement distance varies from user to user, a sensitivity adjusting function is therefore needed for compensate different users. For example, when a finger moves by the same distance, some users may desire to move a pointer by a shorter distance but other users may desire to move a pointer by a longer distance.

Conventionally, the sensitivity of gesture recognition can also be adjusted by executing a separate menu or application which provides the sensitivity adjusting function. However, the conventional technique fails to provide a sensitivity adjusting function which allows a user to immediately adjust the sensitivity while inputting a gesture with a finger during operation, thereby causing the inconvenience of having to stop inputting the gesture to enter a corresponding menu for a sensitivity adjustment for the gesture recognition.

Therefore, there is a need for a scheme by which a user, while controlling an electronic product by inputting a gesture, can immediately adjust sensitivity related to gesture recognition (or gesture input) without entering a separate menu.

### SUMMARY OF THE INVENTION

Accordingly, an aspect of the present invention is to allow a user to use a gesture recognition function by easily adjusting the sensitivity of gesture input while inputting a gesture, without executing a separate menu or application for setting the sensitivity of gesture recognition.

According to an aspect of the present invention, there is provided a method for recognizing a user's gesture in an electronic device, the method including sensing movement of an object by using a motion sensor, checking a distance between the motion sensor and the movement-sensed object and then referring to a preset value which is currently applied in relation to gesture recognition, and adaptively recognizing a gesture corresponding to the movement-sensed object according to the set value and the checked distance on a display screen.

The preset value may be set such that as the distance between the motion sensor and the movement-sensed object increases, a movement distance of the object or the amount of object movement corresponding to a finger gesture non-linearly or linearly increases.

Alternatively, the preset value may be set such that as the distance between the motion sensor and the movement-sensed object increases, a movement distance of the object corresponding to predetermined gesture recognition non-linearly or linearly decreases.

The preset value may be set such that the distance between the motion sensor and the movement-sensed object is divided into several sections, in a predetermined section among the several sections, as the distance between the motion sensor and the movement-sensed object increases, a movement distance of the object corresponding to predetermined gesture recognition non-linearly or linearly increases, and in another section among the several sections, as the distance between the motion sensor and the movement-sensed object increases, a movement distance of the object corresponding to predetermined gesture recognition non-linearly or linearly decreases.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a block diagram of a portable terminal according to an embodiment of the present invention;

FIG. 2A is a flowchart illustrating a process of recognizing a user's gesture according to an embodiment of the present invention;

FIG. 2B is an exemplary diagram showing that after it is determined that change of a set value is requested, the set value is displayed and selected according to an embodiment of the present invention;

FIG. 3A is an exemplary diagram regarding a first set value related to gesture recognition according to an embodiment of the present invention;

FIG. 3B is an exemplary diagram regarding a second set value related to gesture recognition according to an embodiment of the present invention;

FIG. 4A is an exemplary diagram regarding a third set value related to gesture recognition according to an embodiment of the present invention;

FIG. 4B is an exemplary diagram regarding a fourth set value related to gesture recognition according to an embodiment of the present invention; and

FIG. 5 is an exemplary diagram regarding a fifth set value related to gesture recognition according to an embodiment of the present invention.

### DETAILED DESCRIPTION

An embodiment of the present invention regarding adjustment of gesture recognition is assumed to be executed through a commonly used portable terminal, but it may also be applied to any electronic device which includes a motion sensor composed of a camera module, an infrared sensor, or the like. Therefore, gesture recognition according to an embodiment of the present invention may also be implemented on not only portable terminals, but also devices which are not easy to move, such as TVs, game consoles (XBOX, PLAYSTATION, Wii, etc.), computers (personal computers, desktop computers, notebooks, etc.), and so forth.

A portable terminal according to an embodiment of the present invention is a mobile electronic apparatus which is easy to carry, examples of which may include a video phone, a general portable phone (e.g., a feature phone), a smart phone, an International Mobile Telecommunication (IMT)-2000 terminal, a Wideband Code Division Multiple Access (WCDMA) terminal, a Universal Mobile Telecommunication Service (UMTS) terminal, a Personal Digital Assistant (PDA), a Portable Multimedia Player (PMP), a DMB device, an electronic book, a portable computer (e.g., a notebook, a tablet Personal Computer (PC)), a digital camera, and so forth.

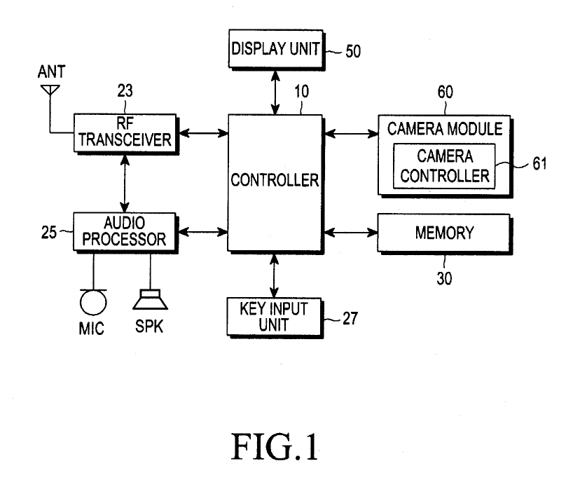

A portable terminal according to an embodiment of the present invention will be described with reference to FIG. 1, which shows is a block diagram of the portable terminal according to an embodiment of the present invention.

Referring to FIG. 1, a Radio Frequency (RF) transceiver 23 performs a wireless communication function of the wireless terminal. The RF transceiver 23 includes an RF transmitter for up-converting a frequency of a transmission signal and amplifying the transmitted signal, and an RF receiver for low-noise amplifying a received signal and down-converting the frequency of the received signal. A modem includes a transmitter for encoding and modulating the transmission signal and a receiver for demodulating and decoding the received signal.

An audio processor 25 may constitute a codec including a data codec and an audio codec. The data codec processes packet data and the audio codec processes audio signals like voice and a multimedia file. The audio processor 25 also converts a digital audio signal received from the modem into an analog audio signal through the audio codec and reproduces the analog audio signal, or converts an analog audio signal generated from a microphone (MIC) into a digital audio signal through the audio codec and transmits the digital audio signal to the modem. The codec may be separately provided or may be included in the controller 10.

A key input unit 27 may include keys for inputting numeric and character information, and function keys or a touch pad for setting various functions. When a display unit 50 is implemented with a touch screen of a capacitive type, a resistive type, etc., the key input unit 27 may include only preset minimum keys, such that the display unit 50 may replace a part of the key input function of the key input unit 27.

The key input unit 27 according to an embodiment of the present invention is temporarily deactivated when an operation mode of the portable terminal is a motion sensing mode (or gesture recognition mode) for recognizing a user's gesture, thereby preventing an unwanted key from being input.

A memory 30 may include program and data memories. The program memory stores programs for controlling a general operation of the portable terminal. The memory 30 may include an external memory such as a Compact Flash (CF), a Secure Digital (SD), a Micro Secure Digital (Micro-SD), a Mini-SD, an Extreme Digital (xD), a memory stick, or the like. The memory 30 may also include a disk such as a Hard Disk Drive (HDD), a Solid State Disk (SSD), etc.

The memory 30 according to an embodiment of the present invention stores one or more set values of a motion sensing mode, and the controller 10 refers to the set values to provide a function of adjusting the sensitivity of gesture recognition to the user.

The display unit 50 may include a Liquid Crystal Display (LCD), or Passive Matrix Organic Light Emitting Diode (PMOLED) or Active Matrix OLED (AMOLED) as an OLED, and outputs display information generated in the portable terminal. The display unit 50 may include a touch screen of a capacitive type, a resistive type, or the like to operate as an input unit for controlling the portable terminal, together with the key input unit 27.

A touch screen function of the display unit 50 according to an embodiment of the present invention is temporarily deactivated when the operation mode of the portable terminal is a motion sensing mode (or gesture recognition mode) for recognizing a user's gesture, thereby preventing an unwanted key from being input.

A camera module 60 converts an optical signal input through lenses (not shown) into an electric image signal and processes the electric image signal. A user may capture a (moving or still) image through the camera module 60.

The camera module 60 may include one or more lenses, a camera sensor, a camera memory, a flash element, a camera controller 61, etc. The lenses collect light and deliver the light to the camera sensor which then converts an optical signal captured during capturing of an image into an electric image signal. The camera memory temporarily stores the captured image, and the flash element provides a proper amount of light according to surrounding conditions at the time of image capturing, and the camera controller 61 controls overall operation of the camera module 60 and converts an analog image signal captured through the camera sensor into digital data. The camera controller 61 may be implemented with an Image Signal Processor (ISP) or a Digital Signal Processor (DSP), and the camera sensor and the camera controller 61 may be implemented separately or integrally.

The camera module 60 according to an embodiment of the present invention may provide a function of measuring a distance between an object and the camera module 60 by using a technique such as phase difference detection. For accurate distance measurement, the camera module 60 according to an embodiment of the present invention may additionally include an ultrasonic transmission/reception device which may measure a distance between an object and the camera module 60 by using a time difference between a transmission ultrasonic signal for the object and an ultrasonic signal received after reflection. Note that measuring a distance between an object and a camera can be performed in a number of other ways that are known by those skilled in the art.

The controller 10 controls overall operation of the portable terminal according to an embodiment of the present invention, and may switch and control an operation of the portable terminal according to user input data that is entered through the key input unit 27 or the display unit 50. The controller 10 according to an embodiment of the present invention senses an object's motion (movement or gesture) through the camera module 60, and switches and controls an operation of the portable terminal, such as the key input unit 27 and the display unit 50, through the sensed object's motion. The controller 10 according to an embodiment of the present invention checks a distance between the camera module 60 and the object whose movement is sensed through the camera module 60, and adjusts the sensitivity of gesture recognition according to the checked distance and a set value of the operation sensing mode.

The camera module 60 according to an embodiment of the present invention is merely an illustrative example of a motion sensor which senses a motion of an object (e.g., a user's finger) and provides a function for controlling the portable terminal (e.g., a gesture recognition function or a motion sensing function), and the camera module 60 may be replaced with an infrared sensor. That is, the camera module 60 or the infrared sensor may be a motion sensor for sensing a movement or motion of an object, and they may be used separately or together. The controller 10 may provide a function of sensing a gesture recognition corresponding to an object's motion using at least one of the camera module 60 and the infrared sensor, and controlling the portable terminal (e.g., movement of a mouse cursor).

Although devices which can be included in the portable terminal, such as a Ground Positioning System (GPS) module, a Bluetooth module, a WiFi module, an acceleration sensor, a proximity sensor, a geo-magnetic sensor, a Digital Media Broadcasting (DMB) receiver, etc. are not shown in FIG. 1, it will be obvious to those of ordinary skill in the art that those devices may also be included in the portable terminal to provide corresponding functions.

For example, the acceleration sensor may be used to sense a motion state of the portable terminal by measuring a dynamic force such as acceleration, vibration, shock, or the like, and sense a display direction of the display unit of the portable terminal through the sensed motion state. The proximity sensor may be used to sense the proximity of a part of a user's body to the portable terminal, thereby preventing malfunction of the portable terminal which provides the touch screen function. The gyroscope observes dynamic motion of the rotating portable terminal and may be used to sense rotating motion along 6 axes of the portable terminal, that is, up or down, left or right, forward or backward, an X axis, a Y axis, and a Z axis, in association with the acceleration sensor.

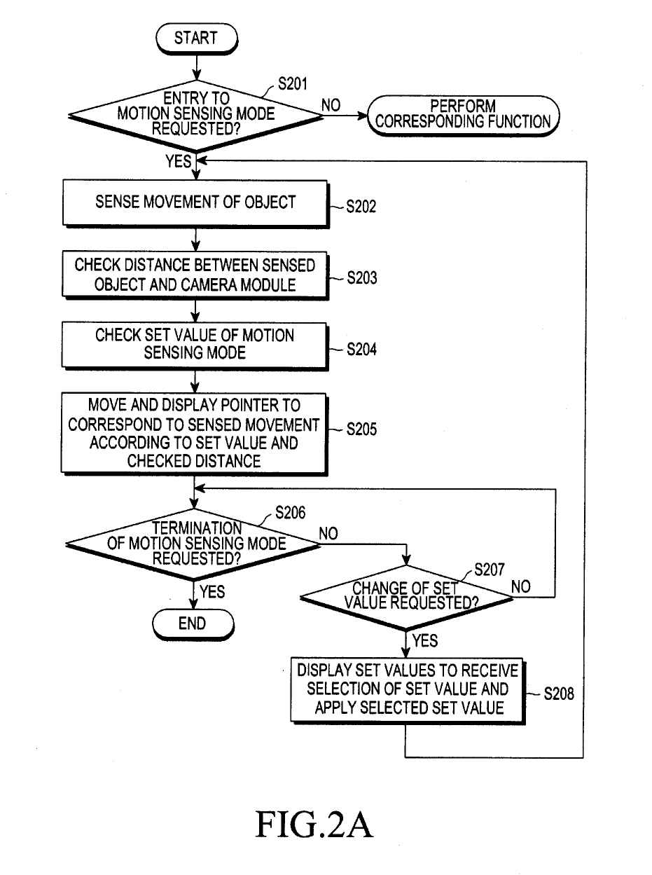

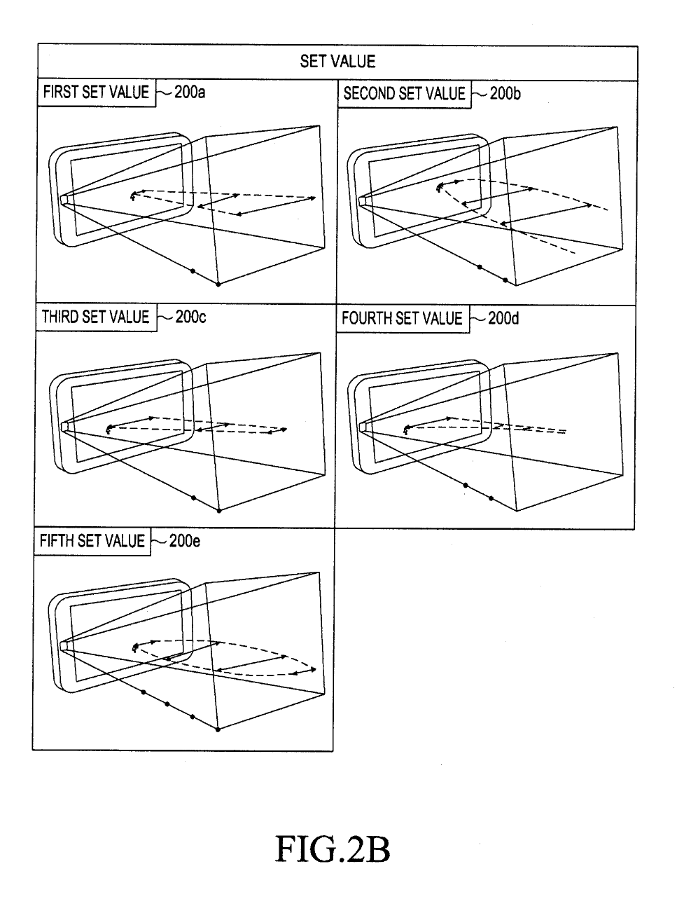

FIG. 2A is a flowchart illustrating a process of recognizing a user's gesture according to an embodiment of the present invention, and FIG. 2B is an exemplary diagram showing that after a set value change request is checked, a set value is displayed and selected according to an embodiment of the present invention.

While it will be described in an embodiment shown in FIG. 2A that controlling a pointer on a display screen is directed to controlling the portable terminal by recognizing a user's gesture, it is merely a representative example of controlling the portable terminal through a gesture recognition. That is, a pointer 51 is moved as a result of adaptively performing the gesture recognition according to a distance between the camera module 60 and an object, but an embodiment of the present invention related to adaptive recognition of a gesture is not limited to pointer's movement. Therefore, it is possible to control the portable terminal in various ways through an adaptively recognized user gesture, and an embodiment of the present invention related to adaptive recognition of the gesture is not limited to controlling pointer's movement.

With reference to FIGS. 2A and 2B, a description will now be made of an embodiment of the present invention.

In steps S201 and S202, the controller 10, upon determining that entry to a motion sensing mode is requested, enters the motion sensing mode to sense an object's motion.

Through input on a touch screen or input of a predetermined key, a user may request entry to the motion sensing mode for controlling the portable terminal by using an object (e.g., a part of a user's body, such as a finger or a hand), and the controller 10 drives the camera module 60 and switches the operation mode of the portable terminal into the motion sensing mode.

In the motion sensing mode, the controller 10 senses object's movement through the camera module 60 which is one of motion sensors for sensing object's movement for gesture recognition. Thus, in an embodiment of the present invention, the camera module 60 may be replaced with a device for sensing object's movement or motion, for example, an infrared sensor. The motion sensor according to an embodiment of the present invention may be equipped with a plurality of camera modules 60 or infrared sensors to rapidly and accurately recognize object's movement. For example, the motion sensor may include two camera modules 60 or three infrared sensors alone or in combination.

In steps S203 through S205, the controller 10 checks a distance between a camera and an object whose movement is sensed and checks a set value of the motion sensing mode to move and display a pointer.

When the user moves an object (e.g., a part of a user's body such as a user's finger or hand), the controller 10 senses a movement of the object through a motion sensor such as the camera module 60. At this time, the controller 10 checks a distance between the object whose movement is sensed and the motion sensor (e.g., the camera module 60). Once checking the distance between the movement-sensed object and the motion sensor, the controller 10 checks a set value (i.e., a value which has been applied or set by default) of the motion sensing mode.

The set value of the motion sensing mode according to an embodiment of the present invention is a set value for setting sensitivity related to gesture recognition variably according to a distance between the camera module 60 and the object when the user inputs a gesture through a movement of the object.

Therefore, the controller 10 according to an embodiment of the present invention, upon checking the distance between the camera module 60 and the movement-sensed (gesture-input) object, checks a set value and adjusts the sensitivity of the input gesture according to the checked distance and set value, thus allowing the user to control the portable terminal (e.g., a pointer's motion) through the sensitivity-adjusted gesture.

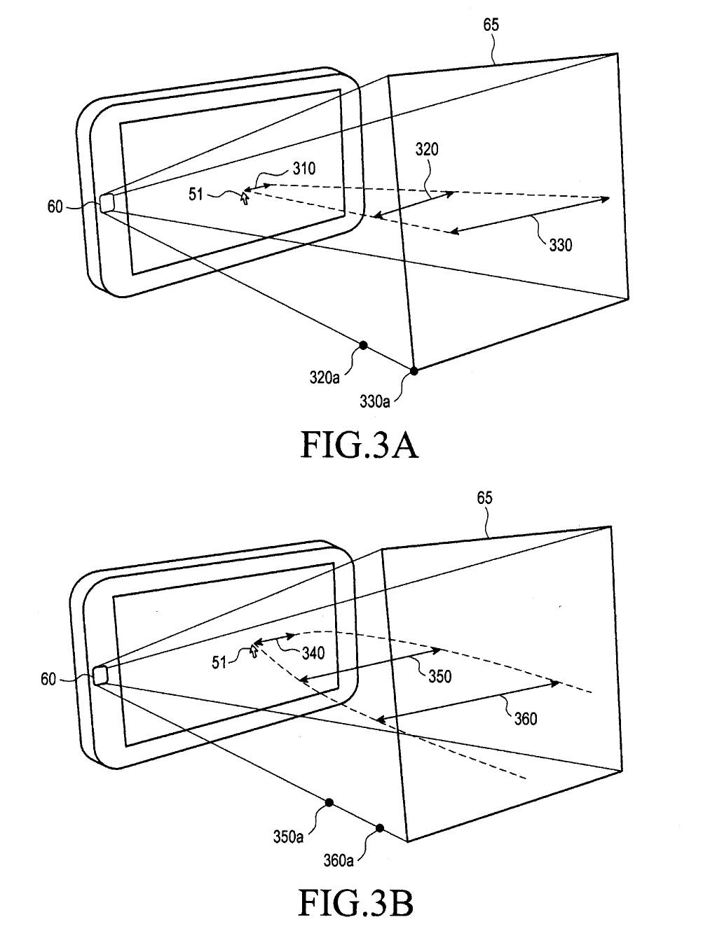

The set value of the motion sensing mode can be described with reference to FIGS. 3A through 5.

The set value will be described with reference to FIG. 3A which is an exemplary diagram regarding a first set value related to gesture recognition according to an embodiment of the present invention.

Referring to FIG. 3A, reference numerals 320a and 330a indicate positions for expressing predetermined distances from a motion sensor (e.g., the camera module 60), and reference numeral 65 indicates a virtual screen for expressing a maximum valid distance in which the camera module 60 can sense object's movement.

In FIG. 3A, the user inputs a gesture by moving an object (e.g., a finger) as indicated by 320 or 330 at the position 320a or 330a, respectively, and according to the user's gesture input, a pointer 51 displayed on a display screen may be moved as indicated by 310.

In FIG. 3A, when the user moves the object (e.g., the finger) as indicated by 320 at the position 320a, the controller 10 moves and displays the pointer 51 as indicated by 310 to correspond to the object's movement indicated by 320. Similarly, when the user moves the object as indicated by 330 at the position 330a, the controller 10 moves and displays the pointer 51 as indicated by 310 to correspond to the object's movement indicated by 330.

In other words, the same result is acquired (that is, the pointer 51 is moved and displayed as indicated by 310) when the object moves as indicated by 320 at the position 320a and when the object moves as indicated by 330 at the position 330a. In other words, the object's movement indicated by 330 needs a larger amount of movement (i.e., a longer movement distance) than the object's movement indicated by 320, which is closer to the camera. This means that the movement of the pointer 51 can be controlled by moving the object at the position 320a a shorter distance than at the position 330a.

Therefore, the first set value described with reference to FIG. 3A is set such that, as the distance between the camera module 60 and the object increases, a movement distance of the object necessary for moving the pointer 51 by the same distance linearly increases.

For example, to acquire the same gesture input result (e.g., the pointer 51 is moved by the same distance), the user has to move the object by a larger distance as the distance between the camera module 60 and the movement-sensed object (e.g., the finger) increases. In other words, as the distance from the camera module 60 to the place of the finger motion increases, the user can more finely or precisely adjust the movement of the pointer 51 as a larger motion is needed for the same result 310.

When inputting a gesture by using the first set value, the user may input the gesture at a position close to the camera module 60 to rapidly move the pointer 51 and may input the gesture at a position away from the camera module 60 to precisely move the pointer 51. In other words, the user may adjust the sensitivity of gesture recognition by adjusting a distance between the camera module 60 and the user's finger.

FIG. 3B is an exemplary diagram regarding a second set value related to gesture recognition according to an embodiment of the present invention.

Referring to FIG. 3B, reference numerals 350a and 360a indicate positions for expressing predetermined distances from a motion sensor (e.g., the camera module 60), and reference numeral 65 indicates a virtual screen for expressing a maximum valid distance in which the camera module 60 can sense object's movement.

In FIG. 3B, the user inputs a gesture by moving the object as indicated by 350 with a distance from the camera module 60 to the position 350a. Then, according to the user's gesture input, the pointer 51 may be moved as indicated by 340. The user inputs a gesture by moving the object as indicated by 360 with a distance from the camera module 60 to the position 360a, and according to the user's gesture input, the pointer 51 may be moved as indicated by 340.

The second set value described with reference to FIG. 3B is similar to the first set value described with reference to FIG. 3A, but they are different from each other in that FIG. 3A corresponds to linearity characteristic and FIG. 3B corresponds to non-linearity characteristic.

In other words, the second set value described with reference to FIG. 3B is set such that, as the distance between the camera module 60 and the object increases, a movement distance of the object necessary for moving the pointer 51 by the same distance (e.g., as indicated by 340) non-linearly increases.

Therefore, when the user moves the pointer 51 as indicated by 340, the user may input a gesture by moving the object at a position close to the camera module 60, such as at the position 350a, to rapidly move the pointer 51 and may input a gesture by moving the object at a position further away from the camera module 60 than the position 350a, such as at the position 360a, to precisely move the pointer 51.

According to the second set value described with reference to FIG. 3B, a movement distance of the object for moving the pointer 51 by the same distance non-linearly increases, such that a change in the sensitivity of gesture recognition according to the distance between the camera module 60 and the object with the second set value is different from that with the first set value. Therefore, the user may select a proper set value between the first set value and the second set value to use the gesture recognition function.

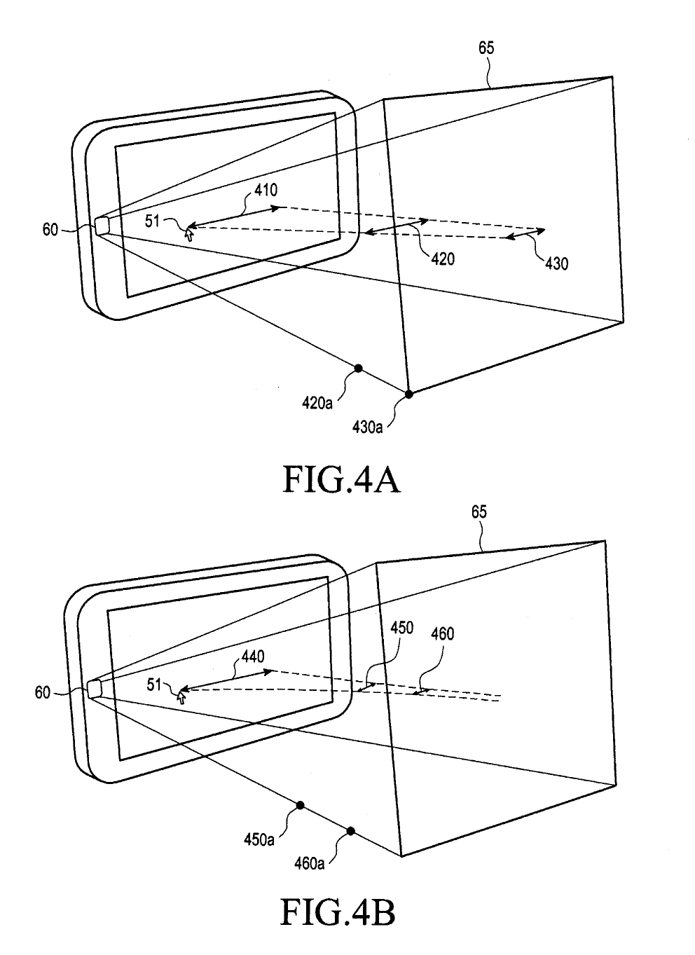

FIG. 4A is an exemplary diagram regarding a third set value related to gesture recognition according to an embodiment of the present invention.

In FIG. 4A, reference numerals 420a and 430a indicate positions for expressing predetermined distances from a motion sensor (e.g., the camera module 60), and reference numeral 65 indicates a virtual screen for expressing a maximum valid distance in which the camera module 60 can sense object's movement.

In FIG. 4A, the user inputs a gesture by moving an object (e.g., a finger) as indicated by 420 or 430 at the position 420a or 430a, and according to the user's gesture input, the pointer 51 displayed on a display screen may be moved as indicated by 410.

The case of FIG. 4A is similar to the case of FIG. 3A in a sense that the movement distance of the object for the same gesture input result (i.e., the pointer 51 is moved as indicated by 410) linearly changes according to the distance between the motion sensor (e.g., the camera module 60) and the motion-sensed object.

Contrary to in FIG. 3A, however, in FIG. 4A, as the distance between the camera module 60 and the motion-sensed object increases, the movement distance of the object necessary for moving the pointer 51 by the same distance linearly decreases.

When inputting a gesture by using the third set value, the user may input the gesture at a position away from the camera module 60 (e.g., at the position 430a) to rapidly move the pointer 51 and may input the gesture at a position close to the camera module 60 (e.g., at the position 420a) to precisely move the pointer 51.

In other words, the gesture is recognized to input the pointer 51 as indicated by 410 by moving the object (i.e., inputting the gesture) at the position 430a by a shorter distance than at the position 420a. Thus, the user can adjust the sensitivity of gesture recognition (e.g., the movement distance of the pointer 51 corresponding to the movement distance of the object) by inputting the gesture while adjusting the distance between the user's finger (i.e., the object) and the camera module 60.

FIG. 4B is an exemplary diagram regarding a fourth set value related to gesture recognition according to an embodiment of the present invention.

Referring to FIG. 4B, reference numerals 450a and 460a indicate positions for expressing predetermined distances from a motion sensor (e.g., the camera module 60), and reference numeral 65 indicates a virtual screen for expressing a maximum valid distance in which the camera module 60 can sense object's movement.

The fourth set value described with reference to FIG. 4B is similar to the third set value described with reference to FIG. 4A, but they are different from each other in that FIG. 4A corresponds to linearity characteristic and FIG. 4B corresponds to non-linearity characteristic.

In other words, the fourth set value described with reference to FIG. 4B is set such that, as the distance between the camera module 60 and the object increases, a movement distance of the object necessary for moving the pointer 51 by the same distance non-linearly decreases.

Accordingly, when inputting a gesture by using the fourth set value, the user may input the gesture at a position away from the camera module 60 (e.g., at the position 460a) to rapidly move the pointer 51 and may input the gesture at a position close to the camera module 60 (e.g., at the position 450a) to precisely move the pointer 51. In other words, the user may control the movement of the pointer 51 by moving the object at the position 460a by a shorter distance than at the position 450a.

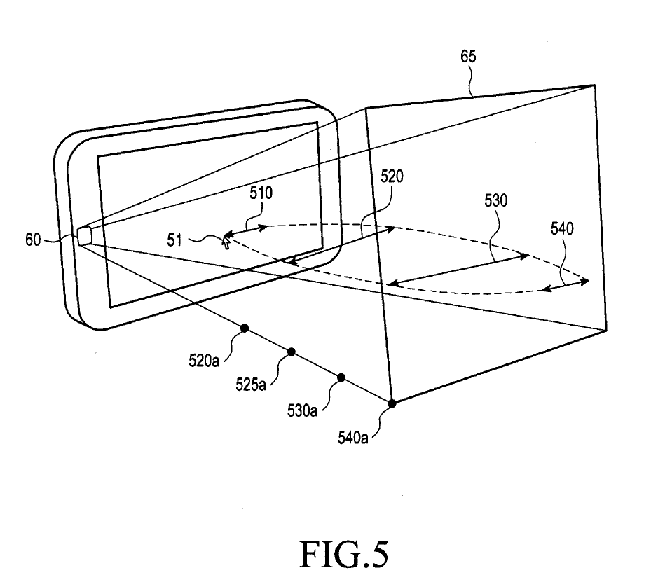

FIG. 5 is an exemplary diagram regarding a fifth set value related to gesture recognition according to an embodiment of the present invention.

Referring to FIG. 5, reference numerals 520a, 525a, 530a, and 540a indicate positions for expressing predetermined distances from a motion sensor (e.g., the camera module 60), and reference numeral 65 indicates a virtual screen for expressing a maximum valid distance in which the camera module 60 can sense object's movement.

According to the fifth set value described with reference to FIG. 5, a distance from a motion sensor (e.g., the camera module 60) to a position corresponding to a maximum valid distance which allows the motion sensor to recognize movement of an object may be divided into several sections and a movement distance of the object necessary for moving the pointer 51 by the same distance (e.g., as indicated by 510) is increased or reduced section-by-section. Instead of dividing the distance from the camera module 60 to the position corresponding to the maximum valid distance, a minimum valid distance and the maximum valid distance which allow the camera module 60 to sense the object's movement may be divided into several sections.

For example, the distance between the camera module 60 and the position corresponding to the maximum valid distance may be divided into two sections, i.e., a first section and a second section.

As shown in FIG. 5, in the first section (e.g., from the camera module 60 to the position 525a), as the distance between the camera module 60 and the movement-sensed object increases, the movement distance of the object (i.e., the gesture's movement distance) necessary for moving the pointer 51 as indicated by 510 non-10 linearly (or linearly) increases. In the second section (e.g., from the position 525a to the position 540a corresponding to the maximum valid distance), as the distance between the camera module 60 and the movement-sensed object increases, the movement distance of the object (i.e., the gesture's movement distance) necessary for moving the pointer 51 as indicated by 510 non-linearly (or linearly) decreases.

Therefore, in the first section from the camera module 60 to the position 525a, the user may input the gesture (i.e., move the object) at a position close to the camera module 60 (e.g., at the position 520a) to rapidly move the pointer 51 and may input the gesture (i.e., move the object) at a position away from the camera module 60 (e.g., at the position 525a) to precisely move the pointer 51.

In the second section from the position 525a to the position 540a, the user may input the gesture (i.e., move the object) at a position away from the camera module 60 (e.g., at the position 540a) to rapidly move the pointer 51 and may input the gesture (i.e., move the object) at a position close to the camera module 60 (e.g., at the position 530a) to precisely move the pointer 51.

The controller 10 determines whether a termination of the motion sensing mode is requested in step S206, and change of a set value in the motion sensing mode is requested in step S207.

The user may request termination of the motion sensing mode by inputting a predetermined gesture (e.g., moving a finger in the shape of X). The user may also request change of a set value by inputting a predetermined gesture (e.g., moving a finger in the shape of a square). Termination of the motion sensing mode or change of the set value may be requested using the key input unit 27 or the touch screen of the display unit 50.

In step S208, the controller 10 displays set values in response to the set value change request to receive user's selection of one of the set values, and continues the motion sensing mode by applying the selected set value.

If determining that change of the set value is requested, the controller 10 displays the set values described with reference to FIGS. 3A through 5 on the display screen of the display unit 50 as shown in FIG. 2B.

When displaying the set values, the controller 10 displays characteristics of each set value in the form of a stereoscopic drawing as shown in FIG. 2B, such that the user may easily check characteristics of the set values expressed with stereoscopic drawings as indicated by 200a through 200e, and may request application of any one of the set values. Application of the set value may be requested by inputting a predetermined gesture (e.g., moving a finger in the shape of a circle) or by using the key input unit 27 or the touch screen of the display unit 50.

As can be seen from the foregoing description, when setting (or adjusting) sensitivity related to gesture recognition or gesture input, the user does not need to execute a separate menu or application for adjusting the sensitivity, and thus does not have to stop inputting the gesture for setting the sensitivity.

Moreover, merely by adjusting the distance between the motion sensor (or an electronic device including the motion sensor) for sensing movement of the object (e.g., the user's finger) and the object, the sensitivity of gesture recognition can be rapidly and conveniently adjusted.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been described in detail, an embodiment mentioned in the course of description is merely illustrative rather than restrictive and changes in components that can be substituted equivalently in the present invention also fall within the scope of the present invention, without departing from the technical spirit and scope of the invention as provided in the accompanying claims.

What is claimed is:

1. A method for recognizing a user's gesture in an electronic device, the method comprising:
sensing a movement of an object using a motion sensor;
determining a distance between the motion sensor and the movement-sensed object to retrieve a preset value corresponding to the determined distance; and
adaptively recognizing a gesture corresponding to the movement-sensed object according to the set value on a display screen.

2. The method of claim 1, further comprising controlling an operation of the electronic device through the adaptively recognized gesture.

3. The method of claim 2, wherein the controlling of the operation of the electronic device comprises moving a pointer on the display screen to correspond to the adaptively recognized gesture.

4. The method of claim 1, further comprising, if sensing that the object is moved in a predetermined shape, through the motion sensor, entering a key input corresponding to the predetermined shape.

5. The method of claim 1, wherein the preset value is set such that as the distance between the motion sensor and the movement-sensed object increases, an amount of the object movement corresponding to the gesture increases non-linearly or linearly.

6. The method of claim 1, wherein the preset value is set such that as the distance between the motion sensor and the movement-sensed object increases, an amount of the object movement corresponding to the gesture increases non-linearly or linearly.

7. The method of claim 1, wherein the motion sensor comprises at least one of a camera module and an infrared sensor.

8. The method of claim 1, further comprising, if sensing that the object is moved in a predetermined shape, displaying types of the preset value and applying a type of the preset value selected from among the displayed types of the preset value.

9. The method of claim 9, wherein the displaying of the types of the preset value comprises displaying each type of the preset value in the form of a corresponding stereoscopic drawing.

10. The method of claim 10, wherein the stereoscopic drawing stereoscopically expresses that a movement distance of the object corresponding to the gesture non-linearly or linearly increases or decreases according to the distance between the motion sensor and the movement-sensed object.

11. The method of claim 1, further comprising selectively changing the preset value in response to a request.

12. The method of claim 1, wherein the preset value is set such that the distance between the motion sensor and the movement-sensed object is divided into several sections, wherein as the distance between the motion sensor and the movement-sensed object increases, an amount of the object movement corresponding to the gesture increases non-linearly or linearly in some sections, and as the distance between the motion sensor and the movement-sensed object increases, an amount of the object movement corresponding to the gesture increases non-linearly or linearly in other sections.

13. A terminal for recognizing a user's gesture on a display screen, comprising:
a memory;
a motion sensor for sensing a movement of an object; and
a controller for determining a distance between the motion sensor and the object to retrieve a preset value stored in the memory corresponding to the determined distance, and adaptively recognizing a gesture corresponding to the movement-sensed object according to the set value on the display screen.

14. The terminal of claim 13, wherein the controller controls an operation of the terminal through the adaptively recognized gesture.

15. The terminal of claim 14, wherein the operation of the terminal comprises moving a pointer on the display screen to correspond to the adaptively recognized gesture.

16. The terminal of claim 13, wherein the pretset value is set such that as the distance between the motion sensor and the movement-sensed object increases, an amount of the object movement corresponding to the gesture increases non-linearly or linearly.

17. The terminal of claim 13, wherein the preset value is set such that as the distance between the motion sensor and the movement-sensed object increases, an amount of the object movement corresponding to the gesture increases non-linearly or linearly.

18. The terminal of claim 13, wherein the controller further selectively changes the preset value in response to a request.
